(19) United States
(12) Patent Application Publication
(10) Pub. No.: US 2012/0030046 A1
(43) Pub. Date: Feb. 2, 2012

(54) System and Method for Buying and Selling Portions of a Composite good in an Electronic Marketplace

(75) Inventor: Kevin Wayne Fullerton, Graham, TX (US)

(73) Assignee: PARTINGOUT.COM LLC, Graham, TX (US)

(21) Appl. No.: 12/844,745

(22) Filed: Jul. 27, 2010

(51) Int. Cl. G06Q 30/00

(52) U.S. Cl. 705/26.1

(57) ABSTRACT

Described herein is an improved system and method for buying and selling portions of a composite good in an electronic marketplace. One method and system comprise communicating to a buyer a first good post associated with a seller, and communicating to a seller a “want to buy” post from the buyer, wherein the “want to buy” post is for a second good different from, but associated with, the first good. Another system and method comprise displaying online a want to buy post from a buyer, for a first good, and communicating to a buyer a seller offer for a second good, associated with the first good.

### BACKGROUND

This disclosure relates to a system and method for buying and selling portions of a composite good in an electronic marketplace.

Electronic commerce, often referred to as eCommerce, consists of the buying and selling of products or services over electronic systems such as the Internet and other computer networks. The amount of trade conducted electronically has grown extraordinarily with widespread Internet usage and has sparked innovations in online transaction processing as well as in electronic funds transferring. Examples of eCommerce include online booksellers Amazon.com and online auction site Ebay, Inc.

In a first type of online transaction, a Seller can “post” an item online for a fixed price, or for a fixed period of time wherein a Buyer can bid on the item. Once the item has been sold, Buyer sends Seller a payment, and Seller sends Buyer the goods. In a second type of online transaction, a Buyer can post a “want to buy” (WTB) notice. Seller can then make an offer to Buyer that he can either choose to accept or reject.

However, in the first transaction described, Seller must post an exact item for sale. Some goods however do not lend themselves to easy posting. For example, individual items or groups of items within a composite good are not often easily posted. For example, a salvage vehicle can have a number of parts, each part capable of being sold as an individual item. Additionally, in the second type of online transaction, the Buyer's WTB notice is not associated with any Seller or Seller posting. As such, the Buyer's WTB notice is not targeted, and has a relatively small chance of finding a willing Seller. It would therefore be advantageous to have an improved system and method for buying and selling portions of a composite good in an electronic marketplace.

### SUMMARY

A method is disclosed for buying and selling a portion of a composite good in an electronic marketplace. In particular, the method comprises communicating to a buyer a first good post associated with a seller; and communicating to a seller a “want to buy” post from the buyer, wherein the “want to buy” post is for a second good different from, but associated with, the first good.

Additionally, a server is disclosed. In particular the server communicates to a buyer a first good post associated with a seller; and communicates to a seller a “want to buy” post from the buyer, wherein the “want to buy” post is for a second good different from, but associated with, the first good.

Further, a method is disclosed for buying and selling a portion of a composite good in an electronic marketplace. In particular, the method comprises displaying online a want to buy post from a buyer, for a first good, and communicating to a buyer a seller offer for a second good, associated with the first good.

Additionally, a server is disclosed. In particular the server displays online a want to buy post from a buyer, for a first good, and communicates to a buyer a seller offer for a second good, associated with the first good.

Lastly, a computer usable medium having a computer readable program code embodied therein is disclosed. The computer readable program code can be adapted to be executed to implement the any of the aforementioned methods performed by the programmed computer processor.

### BRIEF DESCRIPTION OF THE DRAWINGS

FIG. 1 illustrates an eCommerce system.

FIG. 2 illustrates a market server address space.

FIG. 3 illustrates a merchant server address space.

### DETAILED DESCRIPTION

Described herein is an improved system and method for buying and selling portions of a composite good in an electronic marketplace. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), numerous programming decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of database design and management having the benefit of this disclosure. Accordingly, the claims appended hereto are not intended to be limited by the disclosed embodiments, but are to be accorded their widest scope consistent with the principles and features disclosed herein.

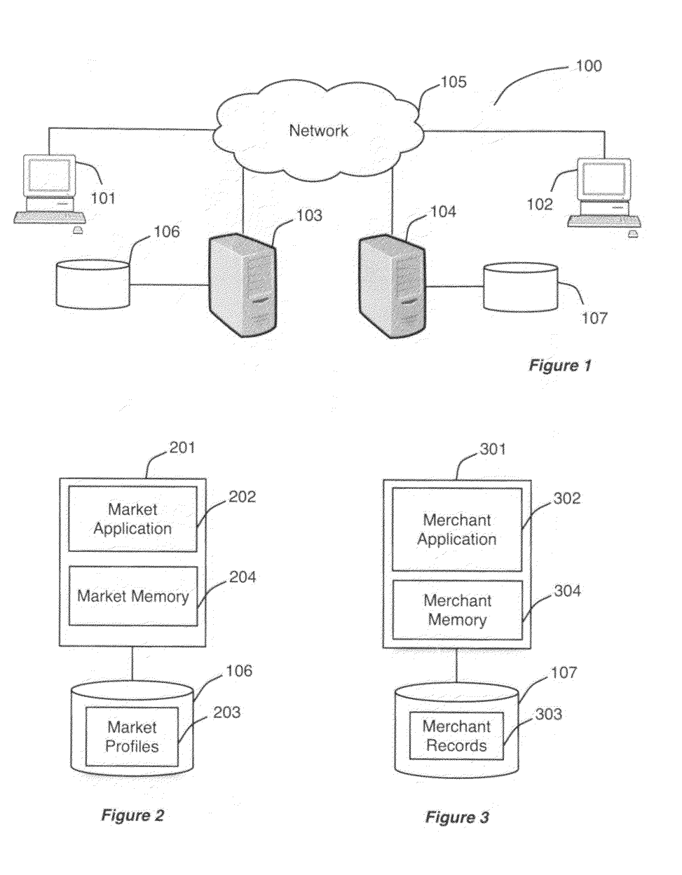

FIG. 1 illustrates an eCommerce system 100 comprising a Buyer computer 101, a Seller computer 102, a market server 103, and a merchant server, all connected by a network 105. Buyer computer 101 and Seller computer 102 can each include, but are not limited to, a laptop, desktop, workstation, server, mainframe, hand held mobile device, and/or terminal. Network 105 can be a local area network (LAN), a wide area network (WAN), a piconet, or a combination of LANs, WANs or piconets. Network 105 can be hard-wired, wireless, or a combination of both. One illustrative LAN is a network within a single business. One illustrative WAN is the Internet. Market server 103 represents at least one, but can be many servers, each connected to network 105. Market server 103 can connect to a market storage device 106. Market storage device 106 can connect directly to market server 103, as shown in FIG. 1, or may exist remotely on network 105. Merchant server 104 represents at least one, but can be many servers, each connected to network 105. Merchant server 104 can connect to a merchant storage device 107. Merchant storage device 107 can connect directly to merchant server 104, as shown in FIG. 1, or may exist remotely on network 105. Market server 103 and Merchant server 104 can be the same server or group of servers. Storage devices 106 and 107 can comprise any suitable long-term or persistent storage device and, further, may be separate devices or the same device and may be collocated or distributed (interconnected via any suitable communications network). Buyer can communicate with market server 103 and merchant server 104 from Buyer computer 101 using an application such as a web browser and/or email. Seller can communicate with market server 103 and merchant server 104 from Seller computer 102 also using an application such as a web browser and/or email.

FIG. 2 illustrates a merchant server address space 201. A market application 202 can execute within market server address space 201. Market application 202 can create and maintain market profiles 203 associated with various buyers and sellers, and store market profiles 203 in market storage device 106. Such profiles make up the online market place. Each market record 203 can include a name of Buyer or Seller (named person or entity can be both Buyer in one transaction and Seller in another transaction) a shipping address, a profile username, a profile password, a payment method such as stored credit card information, an email address, a phone number, composite and/or portions of composite goods for sale, prices associated with each of the composite goods or portion of composite goods, quantities of goods, WTB goods, offer prices associated with WTB goods, Seller associations with WTB goods, and/or a merchant user profile identifier to identify a merchant user profile in merchant storage device 107. In one embodiment an email address can be the market user profile identifier and/or the merchant user profile identifier. Market application 202 can process transactions sent to and from market server 103 as discussed further below. Market server address space 201 can also comprise a market memory 204 that can be used by market application 202 in processing transactions.

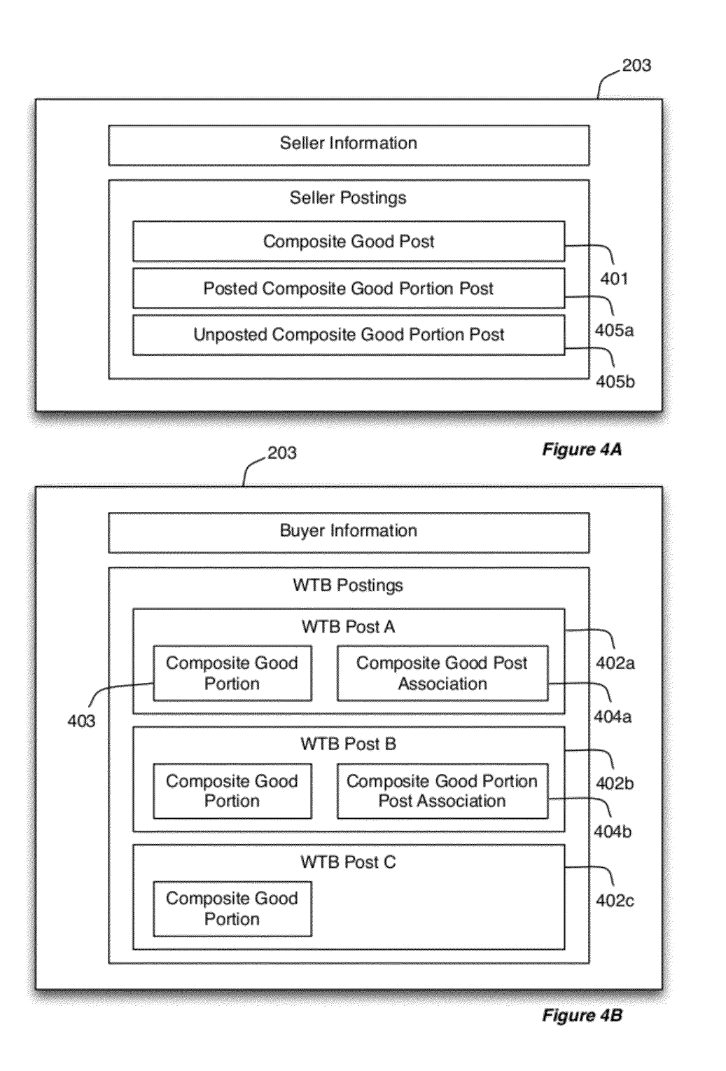

FIG. 3 illustrates a merchant server address space 301. A merchant application 302 can execute within merchant address space 301. Merchant application 302 can create and maintain merchant records 303 associated with Buyer and/or Seller and store merchant records 303 in merchant storage device 107. Merchant record 303 can include a name of an account holder, an account username, an account password, an address, an association with a credit card held by the account holder, an association with a bank account held by the account holder, and/or an email address. Merchant application 302 can process transactions sent to and from merchant server 104, as discussed further below. Merchant server address space 301 can also comprise a merchant memory 304 that can be used by merchant application 302 in processing transactions.

FIG. 4 illustrates Buyer and Seller market profiles 203. FIG. 4A illustrates 203 Seller market profile 203a. FIG. 4B illustrates Buyer market profile 203b. In one embodiment a person can be both a Buyer and a Seller, and thus, market profile can be both Seller market profile 203a and Buyer market profile 203b. In one embodiment, Seller posts a composite good, such as a salvage vehicle, to the online market place. At this time, the composite good post 401 becomes a part of a database of viewable items on the online marketplace. Once composite good post 401 is in the database, Buyer can view composite good post 401. Based upon Buyer's understanding of the salvage vehicle, buyer can, in one embodiment, create a WTB post 402a for a composite good portion 403 and include a composite good post association 404a in WTB post 402a, associating WTB post 402a with composite good post 401. Both composite good post 401 and WTB post 402a can comprise text and or pictures. As an example of an embodiment, Seller might have a 2003 Honda Accord recently involved in a front-end collision. Instead of disassembling the vehicle, determining which parts are salvageable, and posting those parts, a process which is costly and time consuming, Seller might post only the 2003 Honda Accord. Buyer, needing only to replace his rear bumper, can create WTB post 402a associated with Seller's 2003 Honda Accord composite good post 401. In one embodiment, Buyer can define composite good portion 403. In another embodiment, Buyer must choose from a menu of pre-defined composite good portions 403. These composite good portions 403 can be defined by market application 202. Portion of composite good portion 403 can be a single part or a plurality of parts. In one embodiment, WTB post 402a is only viewable by Seller. In another embodiment, the WTB post 402a is viewable by other participants in the online marketplace. In another embodiment, WTB post 402a can include an offer price.

In another embodiment, Seller can post a portion of a posted composite good. Such posting is a posted composite good portion post 405a. In another embodiment, Seller can post a portion of an unposted composite good. Such posting is an unposted composite good portion post 405b. Buyer can infer from composite good portion post 405 that Seller may have a second, different portion of the composite good. As such, Buyer can create WTB post 402b that includes a composite good portion post association 404b. For example, Seller may post a windshield for a 1970 Roadrunner. Buyer has no need for a windshield, but does need the chrome windshield moldings. In such situation, Buyer can post to the Seller his need for the windshield moldings. In such embodiment, the second portion of the composite good can comprise the first portion of the composite good, in whole or in part.

In another embodiment, Buyer can create WTB post 402c for composite good portion 403, not associated with any Seller post.

Market server application 201 can subsequently send a notice to Seller if Buyer includes a composite good post association 404a or composite good portion post association 404b in WTB post 402. Such notice can be an email, a message readable when Seller next logs in to his account, or by any other notification method known in the art. In such embodiment, the notice can be interactive. In one embodiment the notice can allow Seller to click to respond to the notice. Such responses can include “accept” or “reject”, “counter”, or “adopt post” (see infra).

Upon receiving notice, Seller can then determine whether or not he can fulfill the order. Continuing the 2003 Honda Accord example, Seller may look at the vehicle and determine that the bumper is not salvageable. In such event, he can decline WTB post 402. However, if the bumper is salvageable, Seller can have the option to accept WTB post 402 offer. In addition to accepting WTB post 402 offer, Seller can suggest additional portion of composition goods to Buyer. For example, Buyer might have asked for the bumper, but Seller, because of his particular knowledge, might know that Buyer will also need the full bumper assembly, including screws and brackets.

In some situations, Seller might determine that a part requested by Buyer is available and salvageable, but does not wish to fulfill WTB post 402 (for example the offer price may be too low). If so, in one embodiment, Seller can choose to adopt the post, i.e., copy WTB post 402 to his Seller profile, as one of his composite good portion posts 405. In such embodiments, Seller can have the option to modify WTB post 402 (for example change the price) before including it to his profile 203.

In one embodiment the Buyer and Seller can each have a merchant account. Upon acceptance of the WTB post by Seller, funds can be transferred from Buyer's merchant account to Seller's merchant account. In one embodiment, this can happen automatically. In another embodiment, Buyer must manually initiate the transfer.

Various changes in the details of the illustrated operational methods are possible without departing from the scope of the following claims. Some embodiments may combine the activities described herein as being separate steps. Similarly, one or more of the described steps may be omitted, depending upon the specific operational environment in which the method is being implemented. In addition, acts in accordance with the figures may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable storage medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method for buying and selling a portion of a composite good in an electronic marketplace comprising:
providing an application operable by a buyer and a seller over a network;
receiving a want-to-sell post for a composite good by said seller using said application over said network;
writing said want-to-sell post to a first memory space accessible to buyer over said network;
receiving a want-to-buy post for a portion of said composite good by said buyer using said application over said network; and
writing said want-to-buy post to a second memory space accessible to said seller over said network.

2. (canceled)

3. (canceled)

4. The method of claim 1 wherein the composite good is a second portion of a second composite good.

5. (canceled)

6. (canceled)

7. The method of claim 1 further comprising the step of sending said seller an option to write a second want-to-sell post to said first memory, wherein said second want to sell post is based at least in part upon the want to buy post, further wherein said first memory is accessible by a second buyer.

8. The method of claim 1 further comprising writing a second want to sell post to said first memory space, wherein said second want-to-sell post is based at least in part upon said want-to-buy post.

9. A server that
communicates to a buyer a first good post associated with a seller; and communicates to a seller a want to buy post from the buyer, wherein the want to buy post is for a second good different from, but associated with, the first good, further wherein the want to buy post is associated with the first good, further wherein the second good is not individually posted by the seller, further wherein said first good is for a composite good, further wherein said second good is a portion of said composite good.

10. (canceled)

11. (canceled)

12. (canceled)

13. A server that
Displays online a want to buy post from a buyer, for a first good;
Communicating to a buyer a seller offer for a second good, associated with the first good, further wherein the seller offer is associated with the first good, further wherein the second good is not posted by the buyer in a second want to buy post.

14. A computer readable storage medium having a computer readable program code embodied therein, wherein the computer readable program code is adapted to be executed by a computer processor to implement the method of claim 1.

15. (canceled)
